(19) United States
(12) Patent Application Publication
(10) Pub. No.: US 2015/0001301 A1
(43) Pub. Date: Jan. 1, 2015

(54) OPTICAL INDICIA READING TERMINAL WITH COMBINED ILLUMINATION

(71) Applicant: Yunxin Ouyang, Jiangsu (CN)

(72) Inventor: Yunxin Ouyang, Jiangsu (CN)

(73) Assignee: Metrologic Instruments, Inc., Blackwood, NJ (US)

(21) Appl. No.: 14/345,735

(22) PCT Filed: Sep. 26, 2011
(86) PCT No.: PCT/CN2011/001623

§ 371 Date: Jul. 30, 2014

(51) Int. Cl. G06K 7/10; G06K 7/12

(52) U.S. Cl. CPC G06K 7/10732; G06K 7/12
USPC 235/455

(57) ABSTRACT

An optical indicia reading terminal (100) can comprise an image sensor (62,1032), an imaging lens (1110) configured to focus an image of decodable indicia (15) on the image sensor (62,1032), an analog-to-digital converter (1037) configured to convert an analog signal read out of the image sensor (62,1032) into a digital signal representative of light incident on the image sensor (62,1032), a hand held housing (52) encapsulating the image sensor (62,1032), a microprocessor (1060) configured to output a decoded message data corresponding to the decodable indicia (15) by processing the digital signal, and an illumination assembly (1207). The illumination assembly (1207) can include at least one visible spectrum illumination source (322a-322z) and at least one invisible spectrum illumination source (324a-324z). The visible spectrum illumination source (322a-322z) can be configured to emit a light having a wavelength belonging to a visible spectrum region. The invisible spectrum illumination source (324a-324z) can be configured to emit a light having a wavelength belonging to an invisible spectrum region. The intensities of light emitted by the visible spectrum light sources (322a-322z) and invisible spectrum light sources (324a-324z) can be chosen to minimize a perceived combined light intensity while providing an illumination sufficient for obtaining an image suitable for decoding the decodable indicia (15).

### FIELD OF THE INVENTION

The present invention relates to indicia reading terminals in general and in particular to an optical indicia reading terminal.

### BACKGROUND OF THE INVENTION

The use of optical indicia, such as bar code symbols, for product and article identification is well known in the art. Presently, various types of indicia reading terminals have been developed, such as hand-held bar code scanners, hands-free scanners, bi-optic in-counter scanners, and mobile computers such as personal digital assistants (PDAs).

One common type of indicia reading terminal is the digital imager, which includes 1D (linear) imagers and 2D (area) imagers. Digital imagers typically utilize light emitting diodes (LEDs) and a lens to focus the image of the bar code onto a multiple pixel image sensor, which is often provided by a complementary metal-oxide semiconductor (CMOS) image sensor that converts light signals into electric signals. The LEDs simultaneously illuminate all of the bars and spaces of a bar code symbol with light of a specific wavelength in order to capture an image for recognition and decoding purposes.

### SUMMARY OF THE INVENTION

There is provided an optical indicia reading terminal comprising an image sensor, an imaging lens configured to focus an image of decodable indicia on the image sensor, an analog-to-digital converter configured to convert an analog signal read out of the image sensor into a digital signal representative of light incident on the image sensor, a hand held housing encapsulating the image sensor, a microprocessor configured to output a decoded message data corresponding to the decodable indicia by processing the digital signal, and an illumination assembly. The illumination assembly can include at least one visible spectrum illumination source and at least one invisible spectrum illumination source. The visible spectrum illumination source can be configured to emit a light having a wavelength belonging to a visible spectrum region. The invisible spectrum illumination source can be configured to emit a light having a wavelength belonging to an invisible spectrum region. The intensities of light emitted by the visible spectrum light sources and invisible spectrum light sources can be chosen to minimize a perceived combined light intensity while providing an illumination sufficient for obtaining an image suitable for decoding the decodable indicia.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 schematically illustrates one embodiment of an optical indicia reading terminal;

FIG. 2 illustrates a block diagram of one embodiment of the optical indicia reading terminal;

FIG. 3 illustrates one embodiment of an illumination assembly;

FIG. 4 is an exploded perspective view of an imaging module carrying a subset of circuits as shown in FIG. 2;

FIG. 5 is an assembled perspective view of the imaging module as shown in FIG. 4;

FIG. 6 is a perspective view of a hand held indicia reading terminal incorporating an imaging module as shown in FIGS. 4 and 5.

### DETAILED DESCRIPTION OF THE INVENTION

One of the key challenges for imaging and optical indicia reading is the requirement of intense illumination. The magnitude of illumination intensity is directly correlated to the motion tolerance performance of the optical indicia reading device. Current product development of optical indicia reading devices demand that the device perform with extremely high motion tolerance but yield the lowest illumination intensity possible.

In one embodiment, there is provided an optical indicia reading terminal equipped with a two-dimensional image sensor. The associated image sensor circuitry can be configured to read out analog signals representative of light incident on image sensor pixels and then to store a frame of image data in the terminal's memory by converting the analog signals to digital values. The optical indicia reading terminal can be configured to process the frame of image data for decoding decodable indicia. As used herein, “decodable indicia” is intended to denote a representation of a message, such as the representation in a bar code symbology of a character string comprising alphanumeric and non-alphanumeric characters. Decodable indicia can be used to convey information, such as the identification of the source and the model of a product, for example in a UPC bar code that comprises twelve encoded symbol characters representing numerical digits.

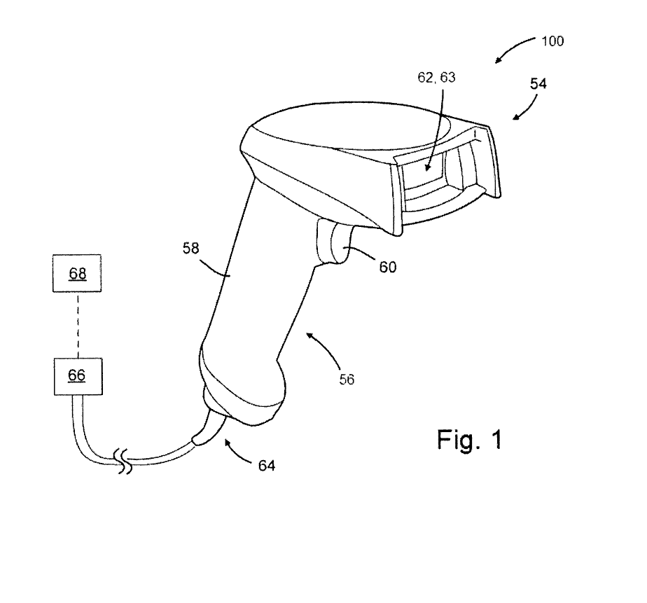

In an illustrative embodiment, shown in FIG. 1, there is provided an optical indicia reading terminal 100 including a housing 52 comprising a head portion 54 and a handle portion 56, the latter further comprising a hand grip 58 and a trigger 60. The trigger 60 can be used to initiate signals for activating frame readout and/or certain decoding processes. Other components of optical indicia reading terminal 100 can be disposed within the housing 52. For example, an image sensor 62 can be disposed in the head portion 54 behind a housing window 63. The image sensor 62 can be configured to output an electrical signal representative of light incident on the image sensor.

Optical indicia reading terminal 100 can further comprise an I/O interface which in the illustrative embodiment of FIG. 1 can be communicatively coupled to a wired connection 66. The I/O interface can be used to communicatively couple optical indicia reading terminal 100 to a companion device 68 such as a register and/or peripheral data capture devices in a point-of-sale (POS) application. Other configurations of the I/O interface may utilize wireless communication technology and/or contact-type features that do not require wires and/or wired connection 66. In certain applications of optical indicia reading terminal 100 for example, the companion device 68 may be provided by a docking station with corresponding mating contacts and/or connectors that are useful to exchange power and data, including image data captured by the imaging module 62.

Although not incorporated in the illustrative embodiment of FIG. 1, optical indicia reading terminal 100 can also comprise a number of peripheral devices, including a display for displaying such information as image frames captured by the terminal, a keyboard, and a pointing device.

Optical indicia reading terminal 100 can be used, for example, for bar code reading and decoding in POS and other applications. A skilled artisan would appreciate the fact that other uses of optical indicia reading terminal 100 are within the scope of this disclosure.

While FIG. 1 illustrates a hand held housing, a skilled artisan would appreciate the fact that other types and form factors of terminal housings are within the scope of this disclosure.

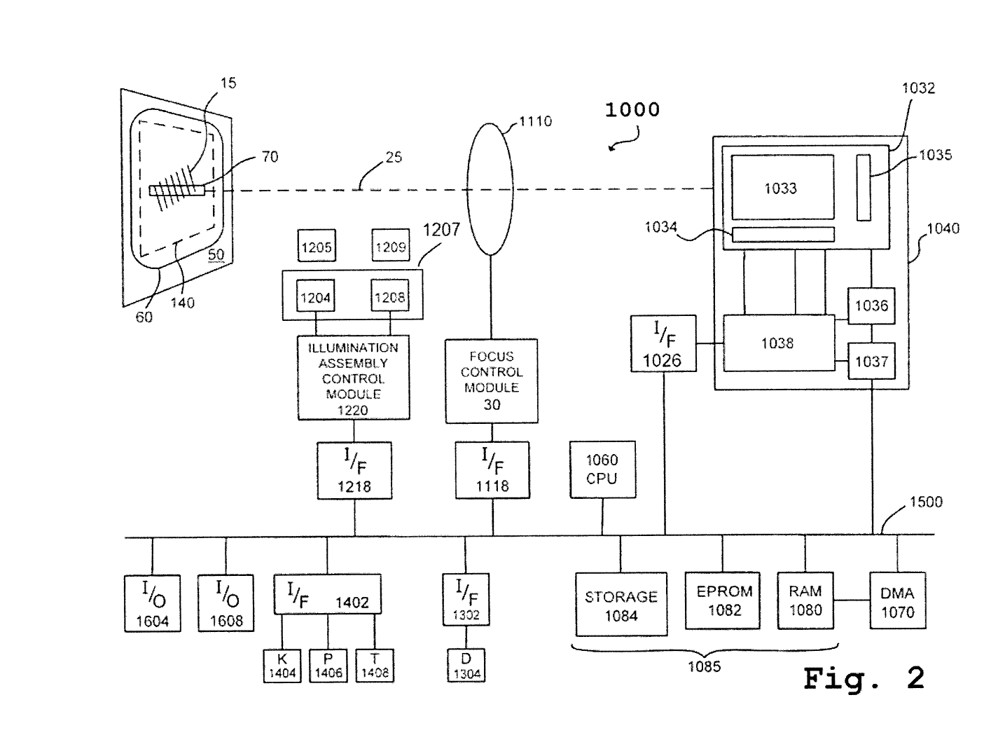

FIG. 2 illustrates a block diagram of one embodiment of the optical indicia reading terminal. Indicia reading terminal 100 can include a color image sensor 1032 comprising a multiple pixel image sensor array 1033 having pixels arranged in rows and columns, associated column circuitry 1034, and row circuitry 1035. In one embodiment, the image sensor array 1033 can be provided by a charge-coupled device (CCD) image sensor. In another embodiment, the image sensor array can be provided by a complementary metal-oxide semiconductor (CMOS) image sensor. A skilled artisan would appreciate the fact that other types of image sensors are within the scope of the invention.

Associated with the image sensor 1032 can be amplifier circuitry 1036, and an analog to digital converter 1037 which converts image information in the form of analog signals read out of image sensor 1033 into image information in the form of digital signals. Image sensor 1032 can also have an associated timing and control circuit 1038 for use in controlling e.g., the exposure period of image sensor 1032, and gain applied to the amplifier circuitry 1036. The noted circuit components 1032, 1036, 1037, and 1038 can be packaged into a common image sensor integrated circuit 1040.

In operation, the light falling on the surface of image sensor 1032 can cause accumulation of charge in each pixel. The indicia reading terminal 100 can be configured to read out analog signals representative of light incident on one or more pixels. The analog signals can then be fed to the input of the ADC 1037. The resulting digital values representative of the analog signals can be stored in a system memory such as RAM 1080. Image frame data stored in RAM 1080 can be in the form of multibit pixel values, with each multibit pixel value representing light incident on a pixel of image sensor 1033. A memory 1085 of terminal 100 can include RAM 1080, a nonvolatile memory such as EPROM 1082 and a storage memory device 1084 such as may be provided by a flash memory or a hard drive memory. Terminal 100 can be further configured to process the stored frame of image data for decoding decodable indicia.

In another aspect, indicia reading terminal 100 can include microprocessor 1060 which can be adapted to read out image data stored in memory 1080 and subject such image data to various image processing algorithms.

In one embodiment, terminal 100 can include a direct memory access unit (DMA) 1070 for routing image information read out from image sensor 1032 that has been subject to conversion and storage to RAM 1080. In another embodiment, terminal 100 can employ a system bus providing for bus arbitration mechanism (e.g., a PCI bus) thus eliminating the need for a central DMA controller. Other embodiments of the system bus architecture and/or direct memory access components providing for efficient data transfer between the image sensor 1032 and RAM 1080 can be provided.

In another aspect, the indicia reading terminal 100 can include a variable focus imaging lens 1110 for use in focusing an image of a decodable indicia located within a field of view 140 on a substrate 50 onto image sensor 1033. Imaging light rays can be transmitted about imaging axis 25. Variable focus imaging lens 1110 can be adapted to be capable of multiple best focus distances and multiple focal lengths. Variable focus imaging lens 1110 can be operative to provide a new best focus distance and/or focal length within a fraction of a frame time in response to an applied input control signal being applied to the variable focus imaging lens 1110. In one embodiment, the variable focus imaging lens 1110 can be provided by a deformable imaging lens, e.g., a deformable fluid lens or gel lens. In another embodiment, the variable focus imaging lens 1110 can be provided by a non-deformable fluid lens, e.g., an electrowetting liquid lens wherein the surface tension of one or more volumes of lens liquid changes in response to a signal being applied to the lens, or a liquid crystal type lens wherein indices of refraction of one or more volumes of lens fluid change in response to a signal being applied to the lens.

The indicia reading terminal 100 can also include an illumination pattern light source bank 1204 for use in generating an illumination pattern 60 substantially corresponding to a field of view 140 of terminal 100 and an aiming pattern light source bank 1208 for use in generating an aiming pattern 70 on substrate 50. Shaping optics 1205 and 1209 can be provided for shaping light from bank 1204 and bank 1208 into pattern 60 and into pattern 70 respectively. In use, terminal 100 can be oriented by an operator with respect to a substrate 50 bearing decodable indicia 15 in such manner that aiming pattern 70 is projected on a decodable indicia 15. In the example of FIG. 2, decodable indicia 15 is provided by a ID bar code symbol. Decodable indicia could also be provided by 2D bar code symbols or optical character recognition (OCR) characters.

Each of illumination pattern light source bank 1204 and aiming pattern light source bank 1208 can include one or more light sources. Variable focus imaging lens 1110 can be controlled with use of focus control module 30 and the illumination assembly 1207 comprising illumination pattern light source bank 1204 and aiming pattern light source bank 1208 can be controlled with use of illumination assembly control module 1220. Focus control module 30 can send signals to variable focus imaging lens 1110 e.g., for changing a best focus distance and/or a focal length of variable focus imaging lens 1110. Illumination assembly control module 1220 can send signals to illumination pattern light source bank 1204 e.g., for changing a level of illumination output by illumination pattern light source bank 1204.

In one example, the indicia reading terminal 100 can be adapted so that illumination assembly control module 1220 controls light source bank 1204 to have a relatively lower level of illumination output when the best focus distance of imaging lens 1110 is set to a first shorter best focus distance, and a relatively higher level of illumination output when the best focus distance of imaging lens 1110 is set at a longer best focus distance. Such variable illumination settings can be varied within a time that trigger signal 502 remains active. The variable illumination level settings can be synchronized to the certain lens settings set forth in connection with the various configurations described herein infra.

Indicia reading terminal 100 can also include a number of peripheral devices, e.g., a display 1304 for displaying such information as captured image frames, keyboard 1404, pointing device 1406, and trigger 1408 which may be used to make active a trigger signal 502 for activating frame readout and/or certain decoding processes. The indicia reading terminal 100 can be adapted so that activation of trigger 1408 activates trigger signal 502 and initiates a decode attempt.

Indicia reading terminal 100 can also include various interface circuits for coupling the peripheral devices to system address/data bus (system bus) 1500, for communication with microprocessor 1060 which can also be coupled to system bus 1500. The indicia reading terminal 100 can include circuit 1026 for coupling image sensor timing and control circuit 1038 to system bus 1500, interface circuit 1118 for coupling focus control module 30 to system bus 1500, interface circuit 1218 for coupling illumination control assembly 1220 to system bus 1500, interface circuit 1302 for coupling display 1304 to system bus 1500, and interface circuit 1402 for coupling keyboard 1404, pointing device 1406, and trigger 1408 to system bus 1500.

In a further aspect, indicia reading terminal 100 can include one or more I/O interfaces 1604, 1608 for providing communications with external devices (e.g., a cash register server, a store server, an inventory facility server, a peer terminal 100, a local area network base station, or a cellular base station). I/O interfaces 1604, 1608 can be interfaces of any combination of known computer interfaces, e.g., Ethernet (IEEE 802.3), USB, IEEE 802.11, Bluetooth, CDMA, GSM.

As noted herein supra, indicia reading terminal 100 can include an illumination assembly 1207 for use in generating an illumination pattern 60. In one embodiment, illumination assembly 1207 can comprise illumination pattern light source bank 1204 and aiming pattern light source bank 1208.

In another aspect, each of illumination pattern light source bank 1204 and aiming pattern light source bank 1208 can include one or more light sources provided, e.g., by light emitting diodes (LEDs).

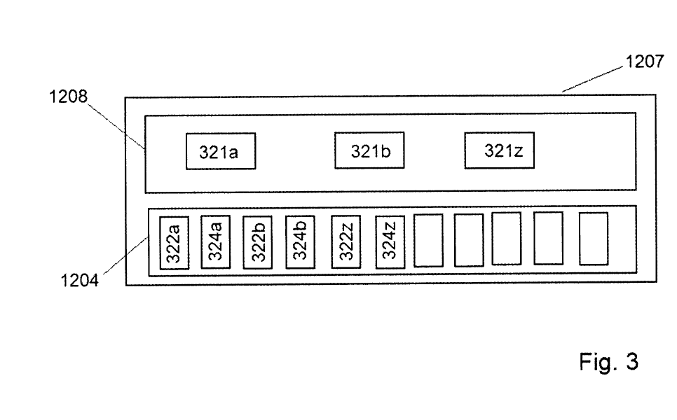

In one embodiment, shown in FIG. 3, aiming pattern light source bank 1208 can comprise one or more illumination light sources 321a-321z. Illumination pattern light source bank 1204 can comprise one or more visible illumination sources 322a-322z configured to emit light having a wavelength belonging to a visible spectrum region, and one or more invisible illumination sources 324a-324z configured to emit light having a wavelength belonging to an invisible (e.g., ultra-violet or infra-red) spectrum region.

In a further aspect, assuming W_{req} being the total illumination power requirement for the imaging field of view (FOV), the emitting power of visible spectrum light sources 322a-322z and invisible spectrum light sources 324a-324z should satisfy the following expression:

$${η}_{receive} ( {\sum }_{i = 1}^{m} {η}_{vis i} {W}_{vis i} + {\sum }_{i = 1}^{n} {η}_{inv i} {W}_{inv i} ) >= {W}_{req} \qquad ( 1 )$$

wherein W_{vis i} is the emitting power of i-th visible spectrum light source;
η_{vis i} is the spectrum response of the image sensor to the wavelength of i-th visible spectrum light source;
m is the total number of visible spectrum light sources;
W_{inv i} is the emitting power of i-th invisible spectrum light source;
η_{inv i} is the spectrum response of the image sensor to the wavelength of i-th invisible spectrum light source;
n is the total number of invisible spectrum light sources; and
η_{receive} is the illumination efficiency (part of total light emitted by all light sources going to the FOV of the sensor).

In one embodiment, the intensities of light emitted by the visible spectrum light sources 322a-322z and invisible spectrum light sources 324a-324z can be chosen not to exceed a given threshold value Iₜᵣ, while providing an illumination sufficient for obtaining an image suitable for decoding said decodable indicia (i.e. the condition (1) must be satisfied):

$${\sum }_{i = 1}^{m} {{η}^{′}}_{vis i} {W}_{vis i} <= {I}_{tr} \qquad ( 2 )$$

wherein η′_{vis i} is the spectrum response of the human eye to the wavelength of i-th visible spectrum light source. Thus, in one embodiment, the intensities of light emitted by the visible spectrum light sources 322a-322z and invisible spectrum light sources 324a-324z can be chosen to satisfy conditions (1) and (2).

In another embodiment, the intensities of light emitted by the visible spectrum light sources 322a-322z and invisible spectrum light sources 324a-324z can be chosen to minimize a perceived combined light intensity while providing an illumination sufficient for obtaining an image suitable for decoding said decodable indicia (i.e., the condition (1) must be satisfied):

$${\sum }_{i = 1}^{m} {{η}^{′}}_{vis i} {W}_{vis i} -- > min \qquad ( 3 )$$

Thus, in one embodiment, the intensities of light emitted by the visible spectrum light sources 322a-322z and invisible spectrum light sources 324a-324z can be chosen to satisfy conditions (1) and (3).

In a further aspect, additional constraints can be formulated, e.g., requiring that the overall number of visible and invisible light sources be less than a pre-defined number N, to allow all light sources be mounted on the housing of terminal 100:

m+n<N (4)

Thus, in one embodiment, the intensities of light emitted by the visible spectrum light sources 322a-322z and invisible spectrum light sources 324a-324z can be chosen to satisfy conditions (1), (3) and (4).

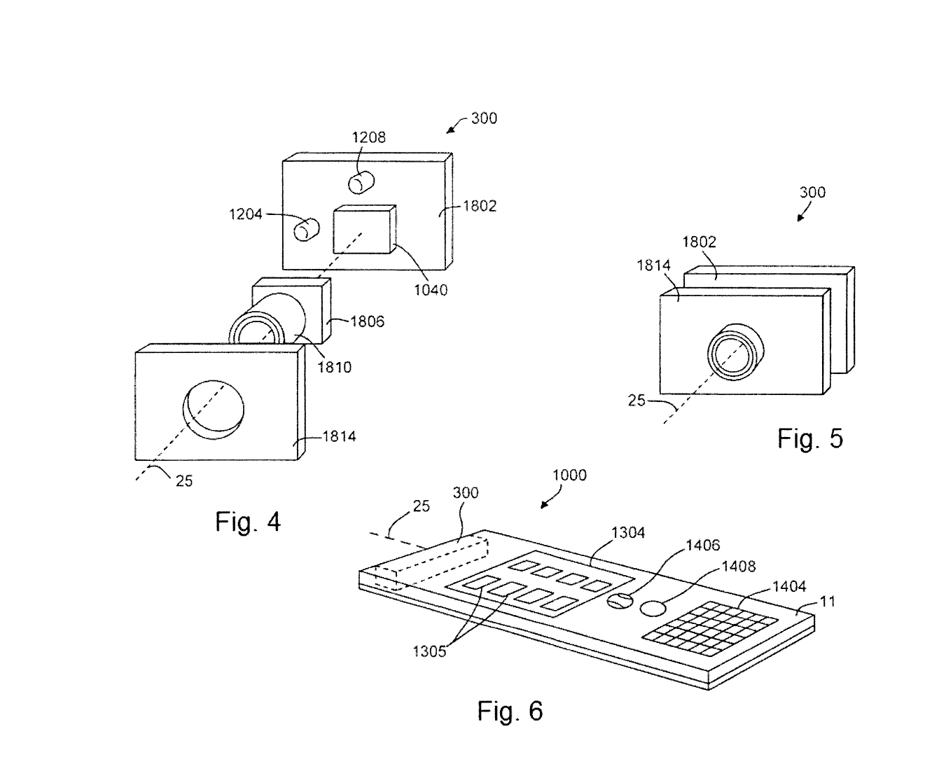

Referring now to FIGS. 4 and 5, an imaging module 300 for supporting components of terminal 100 can include image sensor integrated circuit 1040 disposed on a printed circuit board 1802 together with illumination pattern light source bank 1204 and aiming pattern light source bank 1208 each shown as being provided by a single light source. Imaging module 300 can also include containment 1806 for image sensor integrated circuit 1040, and housing 1810 for housing imaging lens 1110. Imaging module 300 can also include optical plate 1814 having optics for shaping light from bank 1204 and bank 1208 into predetermined patterns. Imaging module 300 can be disposed in a hand held housing 11, an example of which is shown in FIG. 6. Disposed on hand held housing 11 can be display 1304, trigger 1408, pointing device 1406, and keyboard 1404.

A small sample of systems methods and apparatus that are described herein is as follows:

A1. An optical indicia reading terminal comprising:

an image sensor;

an imaging lens configured to focus an image of decodable indicia on said image sensor;

an analog-to-digital converter configured to convert an analog signal read out of said image sensor into a digital signal, said analog signal being representative of light incident on said image sensor;

a hand held housing encapsulating said image sensor;

a microprocessor configured to output a decoded message data corresponding to said decodable indicia by processing said digital signal;

an illumination assembly including at least one visible spectrum illumination source configured to emit a first light having a first wavelength, said first wavelength belonging to a visible spectrum region, and at least one invisible spectrum illumination source configured to emit a second light having a second wavelength, said second wavelength belonging to an invisible spectrum region;

wherein said first light intensity and said second light intensity are chosen to minimize a perceived combined light intensity while providing an illumination sufficient for obtaining an image suitable for decoding said decodable indicia.

A2. The optical indicia reading terminal of A1, wherein said at least one visible spectrum illumination source is provided by at least one light-emitting diode (LED).

A3. The optical indicia reading terminal of A1, wherein said at least one invisible spectrum illumination source is provided by at least one light-emitting diode (LED).

A4. The optical indicia reading terminal of A1, wherein said invisible spectrum region is provided by an ultra-violet spectrum region.

A5. The optical indicia reading terminal of A1, wherein said invisible spectrum region is provided by an infra-red spectrum region.

A6. The optical indicia reading terminal of A1 further including at least one of: a display, a keyboard, and a communication interface.

A7. The optical indicia reading terminal of A1 further including a trigger for activating readout of said analog signal.

A8. The optical indicia reading terminal of A1 further comprising at least one of: an analog signal amplifier and an image sensor control circuit.

A9. The optical indicia reading terminal of A1, wherein said image sensor comprises a multiple pixel image sensor array having pixels arranged in rows and columns, a column circuitry, and a row circuitry.

A10. The optical indicia reading terminal of A1, wherein said image sensor comprises a multiple pixel image sensor array having pixels arranged in rows and columns, said image sensor array provided by a charge-coupled device (CCD) image sensor.

A11. The optical indicia reading terminal of A1, wherein said image sensor comprises a multiple pixel image sensor array having pixels arranged in rows and columns, said image sensor array provided by a complementary metal-oxide semiconductor (CMOS) image sensor.

While the present invention has been described with reference to a number of specific embodiments, it will be understood that the true scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements.

1. An optical indicia reading terminal comprising:
an image sensor;
an imaging lens configured to focus an image of decodable indicia on said image sensor;
an analog-to-digital converter configured to convert an analog signal read out of said image sensor into a digital signal, said analog signal being representative of light incident on said image sensor;
a hand held housing encapsulating said image sensor;
a microprocessor configured to output a decoded message data corresponding to said decodable indicia by processing said digital signal;
an illumination assembly including at least one visible spectrum illumination source configured to emit a first light having a first wavelength, said first wavelength belonging to a visible spectrum region, and at least one invisible spectrum illumination source configured to emit a second light having a second wavelength, said second wavelength belonging to an invisible spectrum region;
wherein said first light intensity and said second light intensity are chosen to minimize a perceived combined light intensity while providing an illumination sufficient for obtaining an image suitable for decoding said decodable indicia.

2. The optical indicia reading terminal of claim 1, wherein said at least one visible spectrum illumination source is provided by at least one light-emitting diode (LED).

3. The optical indicia reading terminal of claim 1, wherein said at least one invisible spectrum illumination source is provided by at least one light-emitting diode (LED).

4. The optical indicia reading terminal of claim 1, wherein said invisible spectrum region is provided by an ultra-violet spectrum region.

5. The optical indicia reading terminal of claim 1, wherein said invisible spectrum region is provided by an infra-red spectrum region.

6. The optical indicia reading terminal of claim 1 further including at least one of: a display, a keyboard, and a communication interface.

7. The optical indicia reading terminal of claim 1 further including a trigger for activating readout of said analog signal.

8. The optical indicia reading terminal of claim 1 further comprising at least one of: an analog signal amplifier and an image sensor control circuit.

9. The optical indicia reading terminal of claim 1, wherein said image sensor comprises a multiple pixel image sensor array having pixels arranged in rows and columns, a column circuitry, and a row circuitry.

10. The optical indicia reading terminal of claim 1, wherein said image sensor comprises a multiple pixel image sensor array having pixels arranged in rows and columns, said image sensor array provided by a charge-coupled device (CCD) image sensor.

11. The optical indicia reading terminal of claim 1, wherein said image sensor comprises a multiple pixel image sensor array having pixels arranged in rows and columns, said image sensor array provided by a complementary metal-oxide semiconductor (CMOS) image sensor.
